(19) United States
(12) Patent Application Publication
(10) Pub. No.: US 2015/0317759 A1
(43) Pub. Date: Nov. 5, 2015

(54) Presenting Career Paths Based On Observed Employment Information

(71) Applicant: Google Inc., Mountain View, CA (US)

(72) Inventors: Yushi Jing, Mountain View, CA (US); Yi Liu, San Bruno, CA (US)

(73) Assignee: Google Inc., Mountain View, CA (US)

(21) Appl. No.: 13/831,209

(22) Filed: Mar. 14, 2013

Related U.S. Application Data
(60) Provisional application No. 61/672,998, filed on Jul. 18, 2012.

(51) Int. Cl. G06Q 10/10

(52) U.S. Cl. CPC G06Q 50/2057; G06Q 10/10

(57) ABSTRACT

In some implementations, a computer-implemented method is provided that includes accessing a database of career path data structures, each career path data structure including an initial node that represents an initial career position, a subsequent node that represents a subsequent career position, and a path element that represents a career transition between the initial career position and the subsequent career position and is associated with data regarding people that have made the career transition between the initial career position and the subsequent career position. The method includes receiving a career path query. The method includes identifying a set of the career path data structures based on the career path query. The method includes generating a set of career paths from the career path data structures, each career path including a directed graph that includes two or more nodes. The method includes providing a representation of the set of career paths.

### CROSS-REFERENCE TO RELATED APPLICATION

This application claims the benefit of U.S. Provisional Application Ser. No. 61/672,998, filed on Jul. 18, 2012, which is incorporated herein by reference.

### FIELD

The present disclosure relates generally to career planning tools.

### BACKGROUND

Career planning is a lifelong process, which includes choosing an occupation, obtaining education or training for that occupation, getting a job, growing in that job, possibly changing careers, and eventually retiring. At one or more different stages of a career, a person may have a desire to reach a particular career position, or have a desire to know what career path options are available given their current career position. One resource for this information may be career-services associated with universities or other educational institutions. Another resource would be to talk to others about their career positions and career paths to their career positions, e.g., alumni, friends, colleagues. Other resources can be found by reviewing career planning websites and resumes of others posted on the Internet.

### SUMMARY

In some implementations, a computer-implemented method is provided that includes accessing a database of career path data structures, each career path data structure including an initial node that represents an initial career position, a subsequent node that represents a subsequent career position, and a path element that represents a career transition between the initial career position and the subsequent career position and is associated with data regarding people that have made the career transition between the initial career position and the subsequent career position. The method includes receiving a career path query. The method includes identifying a set of the career path data structures based on the career path query. The method includes generating a set of career paths from the career path data structures, each career path including a directed graph that includes two or more nodes. The method includes providing a representation of the set of career paths.

One or more of the implementations described herein may have one or more of the following technical advantages. The career path methods and systems employ a large data pool that would be impractical by other methods of career path research. Furthermore, a user is provided with the highest ranking results and likelihood values of obtaining a desired career position for the various career paths that provides the user with knowledge of the risk associated with the various career paths, which is not available in other career path research techniques. Additionally, the building of the career path data structures prior to career path queries facilitates an extensive saving in computer processing time, since the data is collected, analyzed, built into data structures and stored into a single database prior to the receiving and processing of career path queries.

The details of one or more implementations of the subject matter of this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example career path system.

FIG. 2 illustrates an example graphical user interface (GUI) that illustrates different displayed career path data structures in response to a career path query that only indicates an ending career position.

FIG. 3 illustrates an example GUI that illustrates different displayed career path data structure representations in response to a career path query that only indicates a starting career position.

FIG. 4 illustrates an example GUI that illustrates different displayed career path data structures in response to a career path query that indicates both a starting career position and an ending career position.

FIG. 5 illustrates another example GUI that illustrates different displayed career path data structures in response to a career path query that only indicates an ending career position.

FIG. 6 illustrates an example of a method for building career path data structures.

Like reference numbers and designations in the various drawings indicate like elements.

### DETAILED DESCRIPTION

The present disclosure relates generally to career planning tools, and specifically to career path search tools and search techniques. In some implementations, a career path search engine receives career path queries including information about a starting career position and ending career position for the career path. For example, a career path query may specify a starting position of “bus boy” and an ending position of “executive chef” The career path search engine may consult a database of career path information in order to present possible career paths from the starting position to the ending position in response to the career path query. In some implementations, the database of career path information is generated by analyzing employment history documents retrieved from various employment and social networking websites. The employment history documents are analyzed to determine the career path taken by the person associated with each employment history document. These career paths are stored in the database, and retrieved and presented in response to a career path query including the starting, ending, or an intermediate position included in the career path. In some implementations, the career paths are aggregated to determine a likelihood of successful completion of the career path. For example, if only one out of a hundred observed career paths beginning with a starting position of bus boy transitioned to a position of executive chef, a career path starting at bus boy and ending an executive chef may have a low likelihood of successful completion.

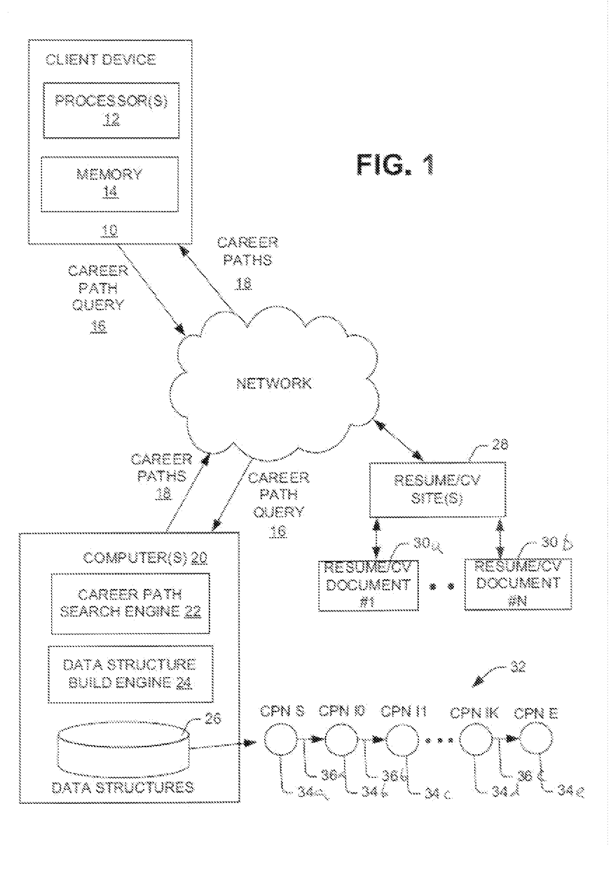

FIG. 1 shows an example career path system. In some implementations, a data structure build engine 24 mines one or more databases including multiple employment history documents. In some implementations, the employment history documents include resumes, curricula vitae (CV), career profile pages from social networking sites (e.g., Google+®, Facebook®, LinkedIn®), and any other suitable documents indicating a person's employment history. In some implementations, the one or more databases may include the social networking sites discussed above or any other suitable websites or data sources including employment history documents. The data structure build engine 24 can mine the one or more databases 26 for trends and/or patterns in career position information to identify various career positions and moves between career positions. Additionally, the data structure build 24 engine can employ one or more web crawlers to crawl the Internet for career position information and build the one or more databases 26 for mining by the data structure build engine 24. The data structure build engine 24 then builds and stores multiple career path data structures 34a-e that represent observed career paths between two or more career positions.

The career path system includes a career path search engine 22, a data structure build engine 24 and multiple career path data structures stored in a career path data structure database 26. The career path search engine 22, the data structure build engine 24 and the career path data structure database 26 can reside on or be distributed across one or more computers 20, e.g., one or more server computers. The one or more computers 20 can be connected to a local area network (LAN) or a wide area network (WAN), such as the Internet. The one or more computers 20 generally, include memory, e.g., random access memory (RAM), read only memory. (ROM), etc., and one or more processors. In some implementations, the career path search engine 22, the data structure build engine 24 and the career path data structure database 26 reside on different computers or are distributed across different computers from one another and can be connected to one another over a LAN or a WAN.

The data structure build engine 24 mines and analyzes multiple employment history documents for position instance information associated with career positions. A career position instance represents a position held by a certain person over a center period of time, and is based on an observed position included in the employment history documents. For example, a career position instance may indicate that a person named John Smith held a patent attorney position at a firm called Smith & Smith from January of 2003 to December of 2006. The career position instance may also include references to the positions held immediately before and after it by the person associated with the position instance. The career position instance may also include information about the person holding the position, such as the person's education history, licenses, skill set or other information indicated in the employment history documents. For example, an employment history document may indicate that John Smith held a Ph. D in Astrophysics from Cornell and law degree from Harvard prior to acquiring the position at Smith & Smith. In such a case, the position instance representing John Smith's time at Smith & Smith may include these credentials.

The employment history documents can be stored as employment history documents 30a-b labeled as #1-#N, where N is a positive integer, at one or more websites over a network. The websites can be resume/CV submission sites, social network sites, career planning sites or a predetermined site for submitting resumes to be employed by the data structure build engine 24. Additionally, employment history documents can be located at other sites, such as company sites, hospital sites and other sites that display information about their respective workers, owners and students, such as law firm sites, hospital sites, and university sites to name a few.

In some implementations, the data structure build engine 24 can employ one or more web crawlers to crawl the Internet for career position information and build a database for mining by the data structure build engine for trends and/or patterns in career position instances to identify various career positions and moves between career positions. For example, the data structure build engine 24 can look for terms in headings such as “Experience”, “Employment”, “Education”, “Skills” and “Qualifications” to facilitate the identification of career position instances, such as position type, entity name, time duration, educational status and skill set status. The data structure build engine 24 can associate different information from the employment history documents to different respective career position instances by matching terms that reside near or adjacent one another, such as different position types, date ranges, entity types or education status. Moves between different career position instances can be determined by looking at different date ranges based on numeric and/or textual formats near or adjacent to different position types, entity names, and educational status and/or by looking at an order of different position types, entity names, and educational status.

The data structure build engine 24 then determines path elements that characterize moves between career position instances. For example, the path element can represent a number of moves from a first career position to a second career position in the analyzed employment history documents. By analyzing the different moves between the first and second career positions, an overall probability or likelihood of the particular move can be determined. The likelihood can be determined by adding up a total number of people that moved from a first career position to a second career position given a total number of people that moved from the first career position to some other career position including the second career position. For example, out of 100 observed moves from the position of “bus boy,” a person has been observed to move to the position of “executive chef” one time. In one example, the likelihood of the transition directly between “bus boy” and “executive chef” could be calculated as a simple probability of the event occurring based on the observed data. Since the transition occurred one time out of 100 occurrences, the likelihood would be 1%. In some implementations, additional factors may be considered when determining the likelihood of a transition, such as, for example, the relationship between the two positions (inside the same organization, etc.), additional education the person obtained while in the first position, additional certifications the person obtained while in the first position, additional experience accumulated while in the first position that may have qualified the person for the second position, and other factors or combinations of factors.

The data structure build engine 24 then builds corresponding career path data structures 32 that are stored in the career path data structure database 26. Each career path data structure 32 includes two or more career position instances 34 that each represent observed positions identified from the employment history documents. The career path data structure 32 also includes one or more path elements 36a-c with each path element characterizing a move between two career position instances 34a-e in the career path data structure 32. Each career path data structure 32 includes a starting career position instance (CPN S) and an ending career position instance (CPN E). Additionally, the career path data structure 32 can include one or more additional intermediate career position instances, labeled CPN I0 through IK, where I represents intermediate career position instances, and K is an integer greater than or equal to zero. The one or more additional intermediate career position instances each represent an observed career position in the career path determined by analyzing the employment history documents.

In some implementations, the career path data may be stored in the database 26 as a set of records representing the individual position instances, and a set of records representing the transitions between the position instances. The career path data may be stored in a single table in the database, in multiple tables in the database, or in any other suitable structure.

A user can interact with the career path search engine 22 through a client device 10. For example, the client device 10 can be a computer coupled to the career path search engine 22 through a local area network (LAN) or a wide area network (WAN), such as the Internet. In some implementations, the search engine 22 and the client device 10 can reside on one machine. For example, a user can install a desktop career search application on the client device 10. Additionally, the career search application can be accessible as a site in a web browser, or as a tab of a site in a web browser. The client device 10 generally includes memory 14, e.g., random access memory (RAM), read only memory (ROM), etc., and one or more processors 12.

A user can submit a career path query 16 to the career path search engine 22 residing on or distributed across the one or more computers 20. The career path query 16 can include at least one of a starting career position and an ending career position. The career path query 16 is transmitted through a network to the career path search engine 22. The search engine 22 can be implemented as, for example, computer programs running on the one or more computers 20 in one or more locations that are coupled to each other through a network. The career path search engine 22 responds to the career path query 16 by identifying career path data structures 32 stored in the career path data structure database 26 that matched the query.

The career path search engine 22 provides search results relevant to submitted career path queries as can be implemented in an internet, an intranet, or another client and server environment. In some implementations, the search engine 22 may respond to a submitted career path query by identifying career paths from the database matching the career path query, and presenting those career paths in response to the career path query. For example, a user may submit a career path query to indicate a desire to see career paths from the position of “bus boy” to “executive chef” In response, the search engine 22 may identify all career paths from the database 26 with an initial position instance of “bus boy” and an ending or intermediate position instance of “executive chef” This identified career path data represents one or more occurrences of this transition in employment history documents analyzed by the search engine 22. The search engine 22 may then present this career path data to the user that submitted the career path query in the form of a graphical output depicting the various career paths, a ranked list of the career paths by likelihood, or any other suitable representation of the career path data.

The career path search engine 22 can retrieve at least a portion of each of a number of identified career path data structures that match the career path search query based on a starting and/or ending career position matching a corresponding starting and/or ending career position instance. For example, a career path data structure can include arc elements and career position instances that correspond to other career positions that occurred prior to and/or after an identified starting career position and/or ending career position that is not within the career path search query. The career path search engine 22 can then strip off these career position instances outside of the intended query prior to providing the identified career path data structure.

Additionally, in some situations a career path search query may include a starting career position instance and/or ending career position instance that does not exactly match a career position instance in the career path data structure database. In this situation, the career path search engine 22 can provide career path data structures that include a career position instance that is a best match for the requested starting career position instance and/or ending career position instance. A best match can be a career position that is synonymous or is the closest position available at a particular entity to the queried starting and/or ending career position. In some implementations, the career search engine 22 can provide identified data structures that include both best matches and exact matches of career position instances to starting and/or ending career positions of a career path search query.

The career path search engine 22 can rank the identified career path data structures and then provide a proper subset of the number of career path data structures matching the career path search query based on the ranking and based on a limited number of graphical representations to be displayed at the client.

The ranking can be based on likelihood, shortest path, shortest time period, or the least number of career moves between a start career position and an end career position or a weighted combination of two or more of the aforementioned ranking parameters. A ranking may be affected by whether an exact match or best match is identified in response to a queried starting and/or ending career position. The career path search engine 22 can then provide a proper subset of the identified career path data structures matching the career path search query based on the ranking and a limited number of graphical representations to be displayed at the client. The limited number of graphical representations, for example, can be user defined or based on practical limitations for displaying of the graphical representations. Additionally, the limited number of graphical representations can be based on a ranking score that exceeds a predefined or user-defined threshold score.

The career path search engine 22 may then aggregate the identified portions of the career path data structures and provide career path data structure results 18, which are transmitted through the network to the client device 10 in a form that can be provided to the user, e.g., as displayed career paths to be displayed in a web browser running on the client device 10. A displayable format can be, for example, as an HTML document, a Java Applet, a format understandable to a one or more types of GUIs, to name a few.

The providing can be in the form of one or more of aggregating the career path data structures and/or formatting the career path data structures at the one or more computers 20, transmitting the career path data structures over the network, receiving the career path data structures at the client device 10 and displaying of the career path data structures at the client device 10. The client device 10 can display the career path data structures in a graphical display executing on the client device 10.

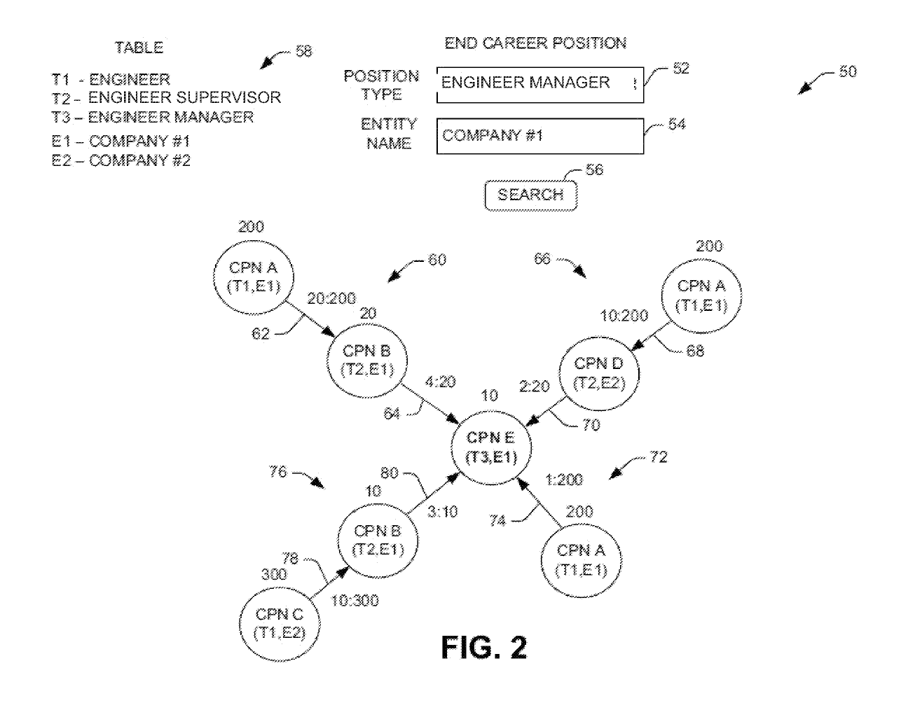

FIGS. 2-5 provide examples of possible graphical user interfaces (GUIs) that can provide graphical representations of the career path data structures at the client device 10. The purpose of the examples of FIGS. 2-5 is to facilitate the understanding of some implementations of the career path data structures and also some possible examples of how the career path data structures can be displayed to a user on a client device. However, it is to be appreciated that a variety of different GUIs and graphical representations could be employed in a variety of implementations to provide a user insight in the displaying of career paths associated with the career path data structures. The examples of FIGS. 2-5 assume exact matches to starting career position instances and/or ending career position instances. However, in some cases an exact match is not available, so best matched career position instances can be employed.

FIG. 2 illustrates an example graphical user interface (GUI) 50 that illustrates different graphical representations of career path data structures in response to a career path query that can be provided at the client device 10 in accordance with some implementations. In the example of FIG. 2, a user is only interested in career paths that result in an end career position. That is, the user desires to view different career paths to a desired end career position. The GUI 50 includes a first query box 52 for inserting or typing text corresponding to a position type of an end career position and a second query box 54 for inserting or typing text corresponding to an entity name of the end career position. The text can be inserted or typed followed by clicking on a search button 56 with a pointer to invoke a career path query. Additionally or alternatively, a pull down menu could be employed for the inserting or typing of text.

In the example of FIG. 2, the term “Engineering Manager” is typed or inserted in the first query box 52 and the term “Company #1” is typed or inserted in the second query box 54. The user desires to view career paths that lead to a career position of being an Engineering Manager at Company #1. The clicking on of the search button 56 invokes a career path query to the search engine 22 that obtains at least portions of career path data structures from the career path data structure database 26 that have an end career position instance CPN E with career position information that includes a position type of Engineering Manager (T3) and an entity name of Company #1 (E1).

In this particular example, the career path search engine 22 provides four career path data structures that are displayed in the GUI 50 as directed graphs with career position instances and path elements in the form of arc elements of the directed graphs all leading to the end career position instance CPN E. A Table 58 illustrates career position information associated with the various career position instances, such as position types and entity names with the various career path data structures. The Table 58 can be for explanatory purposes, and the position types and entity names can be displayed over or adjacent the respective career position instances in some implementations of a GUI.

A first career path data structure 60 includes a starting career position instance CPN A with a position type of Engineer (T1) and entity name of Company #1 (E1), an intermediate career position instance CPN B with a position type of Engineering Supervisor (T2) and entity name of Company #1 (E1), and an end career position instance (CPN E) with the career position of Engineering Manager (T3) and an entity of Company #1 (E1). This illustrates to the user that one potential career path to becoming an Engineering Manager at Company #1 would be to work first as an Engineer at Company #1 and then as an Engineering Supervisor at Company #1 prior to becoming an Engineering Manager at Company #1. This potential career path is identified based on observed career paths taken by others in the analyzed employment history documents. For example, the potential career path presented above may be presented in response to at least one occurrence in an employment history document of a person transitioning between the position of Engineer at Company #1 and transitioning to Engineering Manager at Company #1 in the manner described above.

Additionally, each arc element that couples each career position instance may provide a characterization of the move between the career position instances. This characterizing can be provided as likelihood, a probability, a numerical value or some other indicator that provides a user with an indication of how likely the particular career path is to be successful in concluding in a position as Engineering Manager at Company #1. This characterization could also take into account the number of observed occurrences of people not transitioning to Engineering Manager at Company #1, such as occurrences of people leaving the career path and pursuing a different one

The first career path data structure 60 includes an arc element 62 that couples the starting career position instance CPN A to the intermediate career position instance CPN B and provides a characterization on that career path move that 20 Engineers out of 200 Engineers of Company #1 moved on to become Engineering Supervisors at Company #1. Furthermore, an arc element 64 couples the intermediate career position instance CPN B to the end career position instance CPN E and provides a characterization that 4 of the 20 Engineering Supervisors that were also Engineers at Company #1 moved on to be Engineering Managers of Company #1.

A second career path data structure 66 includes the starting career position instance CPN A, an intermediate career position instance CPN D with a position type of Engineering Supervisor (T2) and entity name of Company #2 (E2), and the end career position instance CPN E. This illustrates to the user that one potential career path to becoming an Engineering Manager at Company #1 would be to work first as an Engineer at Company #1 and then as an Engineering Supervisor at Company #2 prior to becoming an Engineering Manager at Company #1. An arc element 68 couples the starting career position instance CPN C to the intermediate career position instance CPN D and provides a characterization on that career path move that 10 Engineers out of 200 Engineers of company #1 moved on to become Engineering Supervisors of company #2. Furthermore, an arc element 70 couples the intermediate career position instance CPN D to the end career position instance CPN E and provides a characterization that 2 of the 20 Engineering Supervisors of Company #2 that were also Engineers at Company #1 moved on to be Engineering Managers of Company #1.

A displayed third career path data structure 72 includes the starting career position instance CPN A and the end career position instance CPN E. This illustrates to the user that one potential career path to becoming an Engineering Manager at Company #1 would be to work first as an Engineer at Company #1 and then move straight to becoming an Engineering Manager at Company #1. An arc element 74 couples the starting career position instance CPN A to the end career position instance CPN E and provides a characterization that 1 out of 200 Engineers at company #1 moved on to be Engineering Managers of Company #1 without an intermediate career position.

A displayed fourth career path data structure 76 includes a starting career position instance CPN C with a position type of Engineer (T1) and entity name of Company #2 (E2), the intermediate career position instance CPN B, and the end career position instance CPN E. This illustrates to the user that one potential career path to becoming an Engineering Manager at Company #1 would be to work first as an Engineer at Company #2 and then as an Engineering Supervisor at Company #1 prior to becoming an Engineering Manager at Company #1. An arc element 78 couples the starting career position instance CPN C to the intermediate career position instance CPN B and provides a characterization on that career path move that 10 Engineers out of 300 Engineers of Company #2 moved on to become Engineering Supervisors of Company #1. Furthermore, an arc element 80 couples the intermediate career position instance CPN B to the end career position instance CPN E that provides a characterization that 3 out of the 10 Engineering Supervisors of Company #1 that were also Engineers at Company #2 moved on to be Engineering Managers of Company #1.

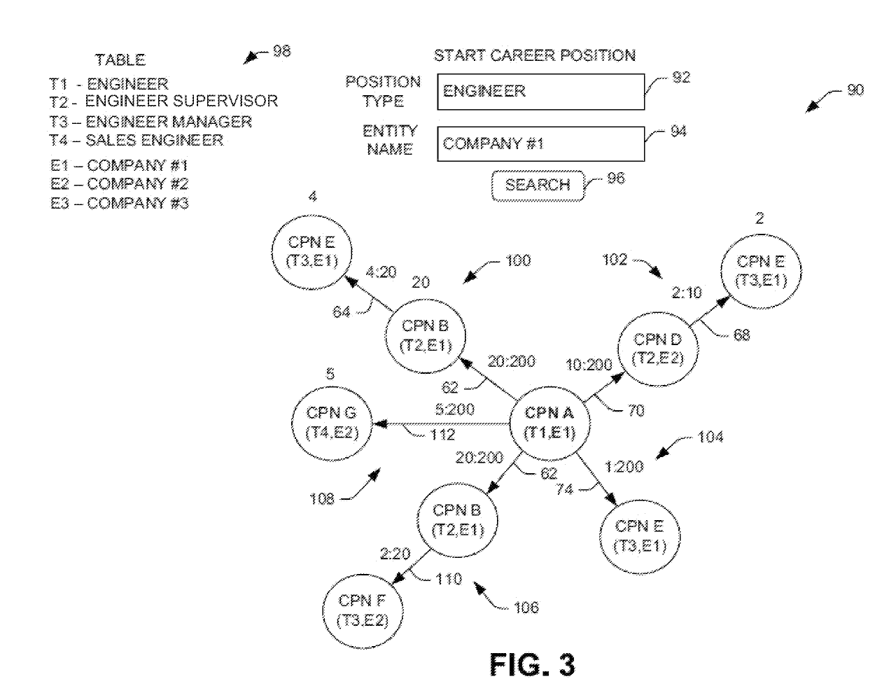

FIG. 3 illustrates an example GUI 90 that illustrates different displayed career path data structures representations in response to a career path query that only indicates a starting career position in accordance with some implementations. In the example of FIG. 3, the user desires to view different career paths based on a starting career position. The GUI 90 includes a first query box 92 for inserting or typing text corresponding to a position type of a starting career position and a second query box 94 for inserting or typing text corresponding to an entity name of the starting career position.

In the example of FIG. 3, the term “Engineering” is typed or inserted in the first query box 92 and the term “Company #1” is typed or inserted in the second query box 94. The user desires to obtain career paths that lead from a career position of beginning as an Engineer at Company #1. The clicking on of a search button 96 invokes a career path query to the search engine 22 that obtains at least portions of career path data structures from the career path data structure database 26 that have the starting career position instance CPN A with career position information that includes a career position of Engineer (T1) at an entity of Company #1 (E1).

In this particular example, the search engine 22 provides five career path data structures that are displayed in the GUI 90 as directed graphs with career position instances and arc elements all leading from the starting career position instance CPN A. A displayed first career path data structure 100 is essential the same as the first career path data structure 60 in FIG. 2, except that the nodes and arcs are directed outwardly from the starting career position instance CPN A to the end career position instance CPN E. This illustrates to the user that one potential career path as an Engineer at Company #1 is to work as an Engineering Supervisor at Company #1 prior to becoming an Engineering Manager at Company #1.

A displayed second career path data structure 102 is essential the same as the second career path data structure 66 in FIG. 2, except that the nodes and arcs are directed outwardly from the starting career position instance CPN A to the end career position instance CPN E. This illustrates to the user that one potential career path to as an Engineer at Company #1 is to work as an Engineering Supervisor at Company #2 prior to becoming an Engineering Manager at Company #1. A displayed third career path data structure 104 is essential the same as the third career path data structure 72 in FIG. 2, except that the nodes and arc are directed outwardly from the starting career position instance CPN A to the end career position instance CPN E. This illustrates to the user that one potential career path as an Engineer at Company #1 is to move to position of an Engineering Manager at Company #1.

A displayed fourth career path data structure 106 includes the starting career position instance CPN A, the intermediate career position instance CPN B, and an end career position instance CPN F with the career position of Engineering Manager (T3) and an entity of Company #2 (E2). This illustrates to the user that one potential career path from a career position of Engineer at Company #1 would be to work first as an Engineering Supervisor at Company #1 prior to becoming an Engineering Manager at Company #2. As previously discussed, the arc element 62 couples the starting career position instance CPN A to the intermediate career position instance CPN B and provides a characterization on that career path move that 20 Engineers out of 200 Engineers of company #1 moved on to become Engineering Supervisors of company #1. Furthermore, an arc element 110 couples the intermediate career position mode CPN B to the end career position instance CPN F and provides a characterization that 2 out of the 20 Engineering Supervisors of Company #1 that were also engineers at Company #1 moved on to be Engineering Managers of Company #2.

A displayed fifth career path data structure 108 includes the starting career position instance CPN A and an end career position instance (CPN G) with the career position of Sales Engineer (T3) and an entity of Company #3 (E3). This illustrates to the user that one potential career path from a career position of Engineer at Company #1 would be to become a Sales Engineer at Company #3. An arc element 112 couples the starting career position instance CPN A to the end career position instance CPN G and provides a characterization that 5 of the 200 Engineers of Company #1 moved on to be Sales Engineer of Company #3.

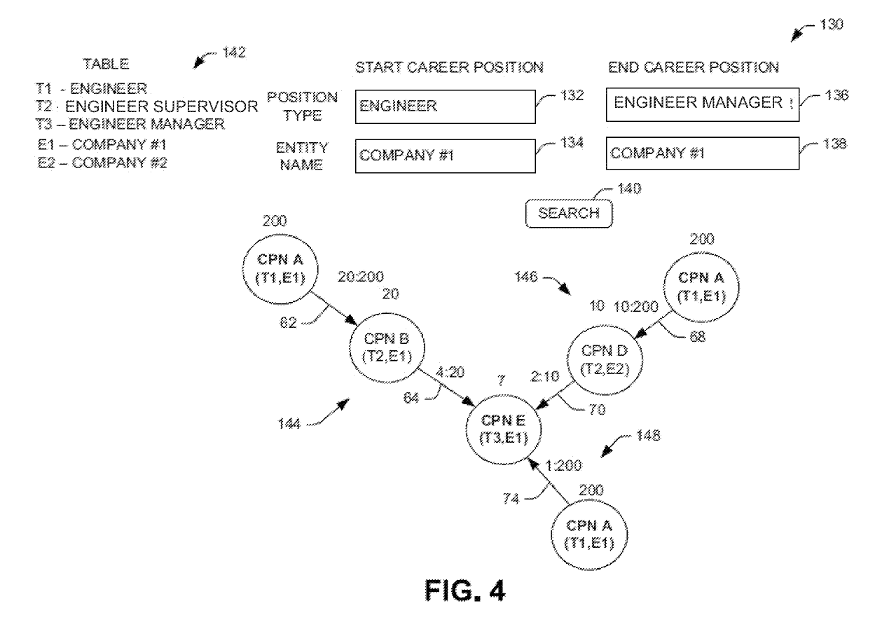

FIG. 4 illustrates a GUI 130 that illustrates different displayed career path data structures in response to a career path query that indicates both a starting career position and an ending career position in accordance with some implementations. In the example of FIG. 4, the user desires to view different career paths based on a starting career position and an ending career position. The GUI 130 includes a first query box 132 for inserting or typing text corresponding to a position type of a starting career position and a second query box 134 for inserting or typing text corresponding to an entity name of the starting career position. The GUI 130 also includes a third query box 136 for inserting or typing text corresponding to a position type of an ending career position and a fourth query box 138 for inserting or typing text corresponding to an entity name of the ending career position.

In the example of FIG. 4, the term “Engineering” is typed or inserted in the first query box 132 and the term “Company #1” is typed or inserted in the second query box 134. The term “Engineering Manager” is typed or inserted in the third query box 136 and the term “Company #1” is typed or inserted in the fourth query box 138. The user desires to obtain career paths from a starting career position as an Engineer at Company #1 and an end career position as an Engineering Manager at Company #1. The clicking on of a search button 140 invokes a career path query to the search engine 22 that obtains at least portions of career path data structures from the career path data structure database 26 that have a starting career position instance CPN A and an ending career position instance CPN E.

In this particular example, the search engine 22 provides three career path data structures that are displayed in the GUI 130 as directed graphs with career position instances and arc elements all leading from the starting career position instance CPN A to an end career position instance CPN E. A displayed first career path data structure 144 is essential the same as the first career path data structure 60 in FIG. 2. This illustrates to the user that one potential career path from Engineer at Company #1 is to work as an Engineering Supervisor at Company #1 prior to becoming an Engineering Manager at Company #1.

A displayed second career path data structure 146 is essential the same as the second career path data structure 66 in FIG. 2. This illustrates to the user that one potential career path from an Engineer at Company #1 is to work as an Engineering Supervisor at Company #2 prior to becoming an Engineering Manager at Company #1. A displayed third career path data structure 148 is essential the same as the third career path data structure 72 in FIG. 2. This illustrates to the user that one potential career path from being an Engineer at Company #1 is to becoming an Engineering Manager at Company #1. Although the arc elements of the data structure are directed from multiple starting position career nodes inwardly to a single ending career position, the data structure could be directed from a single starting position career node to multiple ending career position instances.

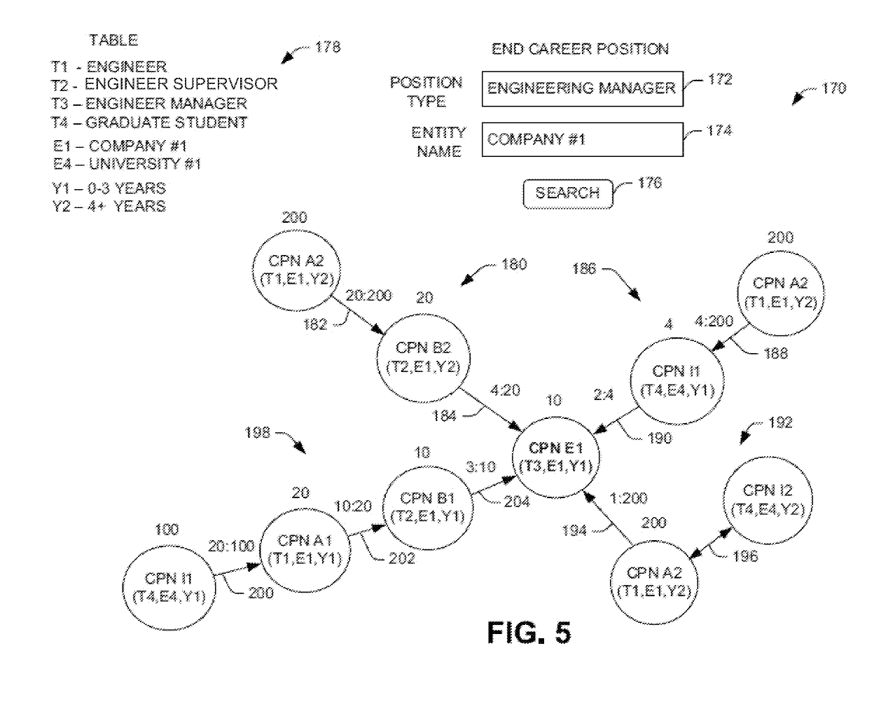

FIG. 5 illustrates an example GUI 170 that illustrates different graphical representations of career path data structures in response to a career path query in accordance with some other implementations. In the example of FIG. 5, career position information associated with career position parameters of career position instances also includes time duration at a career position. In the present example, there are two time durations with one being 0-3 years (Y1) at a career position and the second being 4 or more years (Y2) at a career position, as illustrated in table 178. Additionally, position types can also include other position types than job types, such as a graduate student and entity name can include other entities besides companies, such as universities, as illustrated in table 178.

In the example, of FIG. 5, a user is only interested in career paths that result in an end career position. That is the user desires to view different career paths to a desired end career position. If the user desires career paths that included entering a start career position, the GUI 170 could include an additional query box for entering a number of years at a start career position. The GUI 170 includes a first query box 172 for inserting or typing text corresponding to a position type of an end career position and a second query box 174 for inserting or typing text corresponding to an entity name of the end career position. In the example of FIG. 5, the term “Engineering Manager” has been typed or inserted in the first query box 172 and the term “Company #1” has been typed or inserted in the second query box 174. The user desires to view career paths that lead to a career position of being an Engineering Manager at Company #1. The clicking on of the search button 176 invokes a career path query to the search engine 22 that obtains at least portions of career path data structures from the career path data structure database 26 that have an end career position instance CPN El with career position information that includes a position type of Engineering Manager (T3) and an entity name of Company #1 (El).

In this particular example, the career path search engine 22 provides four career path data structures that are displayed in the GUI 170, as directed graphs with career position instances and path elements in the form of arc elements of the directed graphs all leading to the end career position instance CPN E1. The Table 178 illustrates career position information associated with the various career position instances, such as position types, entity names and time duration at a career position associated with the various career path data structures.

A first career path data structure 180 includes a starting career position instance CPN A2 with a position type of Engineer (T1), entity name of Company #1 (E1) and position time duration of 4+ years (Y2), an intermediate career position instance CPN B2 with a position type of Engineering Supervisor (T2), entity name of Company #1 (E1) and position time duration of 4+ years (Y2), and an end career position instance CPN E with the career position of Engineering Manager (T3) an entity name of Company #1 (E1). This illustrates to the user that one potential career path to becoming an Engineering Manager at Company #1 would be to work first as an Engineer at Company #1 for four or more years and then as an Engineering Supervisor at Company #1 for four or more years prior to becoming an Engineering Manager at Company #1.

Additionally, the first career path data structure 180 includes an arc element 182 that couples the starting career position instance CPN A2 to the intermediate career position instance CPN B2 and provides a characterization on that career path move that 20 Engineers out of 200 Engineers of Company #1 that worked for four or more years as an Engineer moved on to become Engineering Supervisors at Company #1. Furthermore, an arc element 184 couples the intermediate career position instance CPN B2 to the end career position instance CPN E1 and provides a characterization that 4 out of the 20 Engineering Supervisors that worked four or more years as an Engineering Supervisor at Company #1 that were also Engineers at Company #1 for four or more years moved on to be Engineering Managers of Company #1.

A second career path data structure 186 includes a starting career position instance CPN A2, an intermediate career position instance CPN I1 with a position type of Graduate Student (T4) and entity name of University #1 (E4), and the end career position instance CPN E1. This illustrates to the user that one potential career path to becoming an Engineering Manager at Company #1 would be to work first as an Engineer at Company #1 for four or more years and then attend graduate school at University #1 for zero to three years prior to becoming an Engineering Manager at Company #1. An arc element 188 couples the starting career position instance CPN A2 to the intermediate career position instance CPN I1 and provides a characterization on that career path move that 4 Engineers out of 200 Engineers of company #1 attended graduate school at University #1. Furthermore, an arc element 190 couples the intermediate career position mode CPN I1 to the end career position instance CPN E1 and provides a characterization that 2 of the 4 Graduates Students that attended University #1 for zero to three years and that were also Engineers at Company #1 for zero to three years moved on to be Engineering Managers of Company #1.

A displayed third career path data structure 192 includes a starting career position instance CPN A2 and the end career position instance CPN E1. The third career path data structure 192 also includes a secondary career position instance CPN I2 that is bi-directionally coupled by an arc element 196. This illustrates the situation when a person has maintained two concurrent positions, such as, for example, when a person attends college while also maintaining a job. The bi-directional coupling of the secondary career position instance CPN I2 to the starting career position instance CPN A2 indicates to the user that one potential career path to becoming an Engineering Manager at Company #1 would be to work first as an Engineer at Company #1 for four or more years, while also attending graduate school as a Graduate Student at University #1 for four or more years prior to becoming an Engineering Manager at Company #1. An arc element 194 couples the starting career position instance CPN A2 to the end career position instance CPN El and provides a characterization that 1 out of 200 Engineers at company #1 that worked for four or more years that were also Graduate Students at University #1 for four or more years moved on to be Engineering Managers of Company #1.

A displayed fourth career path data structure 198 includes a starting career position instance CPN I1, a first intermediate career position instance CPN A1 with a position type of Engineer (T1), entity name of Company #1 (E1) and career position duration of 0-3 years (Y1), a second intermediate career position instance with a position type of Engineering Supervisor (T2), entity name of Company #1 (E1), and the career position duration of 0-3 years (Y1), and the end career position instance (CPN E1). This illustrates to the user that one potential career path to becoming an Engineering Manager at Company #1 would be to first attend graduate school for zero to three years, work as an Engineer at Company #1 for zero to three years, then as an Engineering Supervisor at Company #1 for zero to three years prior to becoming an Engineering Manager at Company #1.

An arc element 200 couples the starting career position instance CPN I1 to the first intermediate career position instance CPN A1 and provides a characterization on that career path move that 20 out of 100 Graduate Students at University #1 become Engineers at Company #1. An arc element 202 couples the first intermediate node CPN A1 to the second intermediate node CPN A1 and provides a characterization on that career path move that 10 out of the 20 Engineers at Company #1 that were initially Graduate Students at University #1 moved on to become Engineering Supervisors of Company #1. Furthermore, an arc element 204 couples the second intermediate career position mode CPN Bl to the end career position instance CPN E1 and provides a characterization that 3 of those Engineering Supervisors moved on to be Engineering Managers of Company #1.

The GUIs illustrated with respect to FIGS. 2-5 were possible examples of how to provide alternative career path visualization (representation) to a user corresponding to career path data structures, and a variety of other GUI implementations could be employed to carry out this objective. For example, the career paths can be shown as horizontal linear arrays with the shortest path or more traveled path displayed on top. Furthermore, paths may be shown as vertical linear arrays. Additionally, the present examples only illustrate advancements between positions, but career paths may include taking a lower career position from the current career position to eventually get to a higher career position. A variety of techniques could be employed to illustrate this type of career path, for example, in the previously mentioned linear array displays. In some implementations, the career paths may be presented in a web page, such as by generating an image representing the career paths and embedding the generated image in a web page returned in response to the career search query.

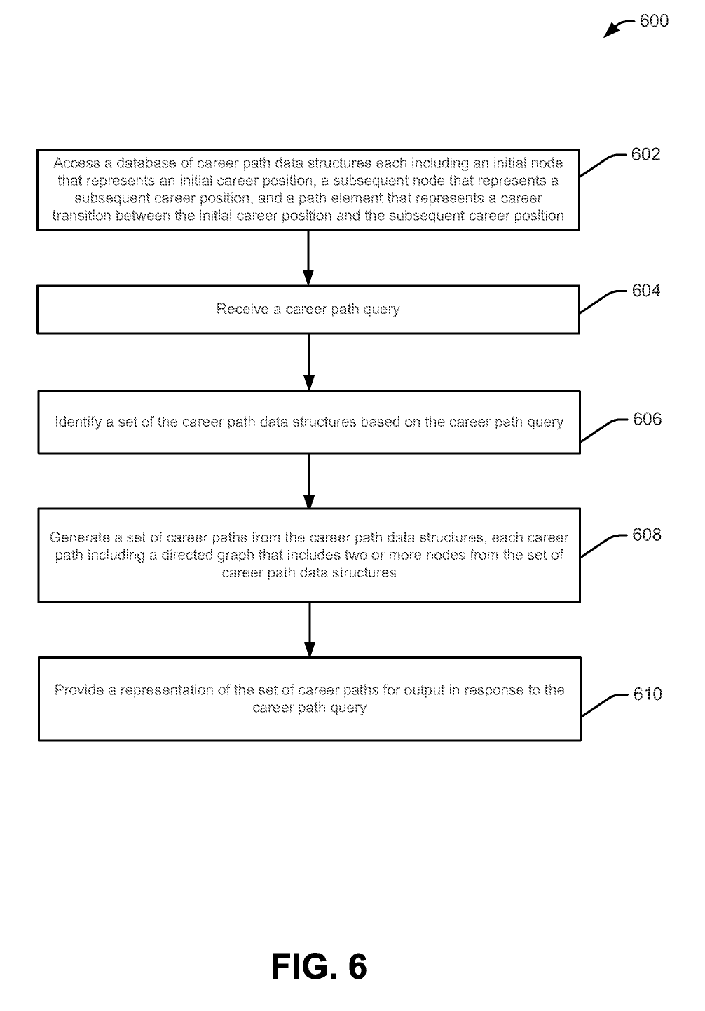

In view of the foregoing structural and functional features described above, methodologies in accordance with various implementations will be better appreciated with reference to FIG. 6. While, for purposes of simplicity of explanation, the method of FIG. 6 is shown and described as executing serially, it is to be understood and appreciated that the method is not limited by the illustrated order, as some implementations could occur in different orders and/or concurrently with other implementations from that shown and described herein. Moreover, not all illustrated features may be required to implement a method.

FIG. 6 illustrates an example of a method 600 for analyzing and presenting career path information based on career path data structures. At 602, a database of career path data structures is accessed, each career path data structure including an initial node that represents an initial career position, a subsequent node that represents a subsequent career position, and a path element that represents a career transition between the initial career position and the subsequent career position. In some implementations, the career path data structures are associated with data regarding people that have made the career transition between the initial career position and the subsequent career position. In some implementations, the career path data structures are generated based on employment history documents retrieved from the Internet or from other sources of employment data. The career path structures may also include additional qualification information associated with the people that have made the career transitions, such as education information, certification information, licenses, or any other suitable qualification information.

At 604, a career path query is received. In some implementations, the user may enter the career path query into a webpage. The career path query may also be received from an external system, such as via an Application Programming Interface “API”.

At 606, a set of career path data structures is identified based on the career path query. In some implementations, the set of career path data structures is identified by submitting a query to the database of career path data structures including one or more terms or parameters associated with the career path query. The career path query may also be submitted directly to the database of career path structures, such as implementations where the career path query is formatted in a database query language such as Structured Query Language (SQL).

At 608, a set of career paths is generated from the career path data structures, each career path including a directed graph that includes two or more notes from the set of career path data structures. In some implementations, the set of career paths is generated in response to receiving the career path query. The set of career paths may also be generated prior to receiving the career path query.

At 610, a representation of the set of career passes provided for output in response to the career path query. In some implementations, as previously described, the representation of the set of career paths may be provided in a webpage presented to the user that submitted the career path query.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example, a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program, also known as a program, software, software application, script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the subject matter described in this specification can be implemented in a computing system that includes a back-end component, e.g., as a system that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What have been described above are example implementations. It is, of course, not possible to describe every conceivable combination of components or methodologies, but one of ordinary skill in the art will recognize that many further combinations and permutations are possible. Accordingly, the present disclosure is intended to embrace all such alterations, modifications and variations.

1. A computer-implemented method comprising:
populating a searchable database of career path objects based on an automated analysis of a collection of employment history resources, each career path object including (i) an initial node that represents an observed initial career position that is included in one or more of the employment history resources, (ii) an observed subsequent node that represents a subsequent career position that is included in one or more of the employment history resources, and (iii) a path element that represents a career transition between the observed initial career position and the observed subsequent career position, and that is associated with data that reflects a number of people that the employment history resources indicate have made the career transition between the initial career position and the subsequent career position;
receiving, by a career path search engine, a career path query that indicates at least one of an initial career position or a subsequent career position;
identifying, the career path search engine, a set of the career path objects that, when joined, define career paths from the initial career position, or to the subsequent career position, indicated in the career path query;
determining an observed career path likelihood score for each career path based on the number of people that the employment history resources indicate have made the career transition for each career path object of the career path;
ranking the career paths based on the observed career path likelihood scores;
selecting one or more of the top N-ranked career paths; and
providing, by the career path search engine, a search results page that includes a representation of the selected one or more top N-ranked career paths for output in response to the career path query.

2-20. (canceled)

21. The method of claim 1, further comprising:
identifying a set of employment history documents from one or more web sites;
analyzing the employment history documents to determine observed career path data representing career paths taken by people associated with the employment history documents;
generating the career path objects based on the career path data; and
storing the career path objects in the database of career path objects.

22. The method of claim 21, wherein the employment history documents include resumes, curricula vitae, and employee information web pages.

23. The method of claim 1, wherein the initial and subsequent nodes include qualification information representing additional qualifications possessed by the people associated with the positions represented by the nodes.

24. The method of claim 23, wherein the additional qualifications include education information.

25. The method of claim 1, further comprising:
determining a likelihood of success for each observed career path in the set of career path objects based at least in part on the number of people who successfully made the career transition, wherein providing the representation of the one or more top N-ranked career paths includes providing a representation of the determined likelihood of success of each career path.

26. A tangible, non-transitory computer-readable medium encoded with instructions for causing one or more processors to perform operations comprising:
populating a searchable database of career path objects based on an automated analysis of a collection of employment history resources, each career path object including (i) an initial node that represents an observed initial career position that is included in one or more of the employment history resources, (ii) an observed subsequent node that represents a subsequent career position that is included in one or more of the employment history resources, and (iii) path element that represents a career transition between the observed initial career position and the observed subsequent career position, and that is associated with data that reflects a number of people that the employment history resources indicate have made the career transition between the initial career position and the subsequent career position;
receiving, by a career path search engine, a career path query that indicates at least one of an initial career position or a subsequent career position;
identifying, by the career path search engine, a set of the career path objects that, when joined, define career paths from the initial career position, or to the subsequent career position, indicated in the career path query;
determining an observed career path likelihood score for each career path based on the number of people that the employment history resources indicate have made the career transition for each career path object of the career path;
ranking the career paths based on the observed career path likelihood scores;
selecting one or more of the top N-ranked career paths; and
providing, by the career path search engine, a search results page that includes a representation of the selected one or more top N-ranked career paths for output in response to the career path query.

27. The computer-readable medium of claim 26, the operations further comprising:
identifying a set of employment history documents from one or more web sites;
analyzing the employment history documents to determine observed career path data representing career paths taken by people associated with the employment history documents;
generating the career path objects based on the career path data; and
storing the career path objects in the database of career path objects.

28. The computer-readable medium of claim 26, wherein the employment history documents include resumes, curricula vitae, and employee information web pages.

29. The computer-readable medium of claim 26, wherein the initial and subsequent nodes include qualification information representing additional qualifications possessed by the people associated with the positions represented by the nodes.

30. The computer-readable medium of claim 26, wherein the additional qualifications include education information.

31. The computer-readable medium of claim 26, the operations further comprising:
determining a likelihood of success for each observed career path in the set of career path objects based at least in part on the number of people who successfully made the career transition, wherein providing the representation of the one or more top N-ranked career paths includes providing a representation of the determined likelihood of success of each career path.

32. A system, comprising:
memory operable to store a business process; and
at least one hardware processor interoperably coupled to the memory and operable to:
populate a searchable database of career path objects based on an automated analysis of a collection of employment history resources, each career path object including (i) an initial node that represents an observed initial career position that is included in one or more of the employment history resources, (ii) an observed subsequent node that represents a subsequent career position that is included in one or more of the employment history resources, and (iii) a path element that represents a career transition between the observed initial career position and the observed subsequent career position, and that is associated with data that reflects a number of people that the employment history resources indicate have made the career transition between the observed initial career position and the observed subsequent career position;
receive, by a career path search engine, a career path query that indicates at least one of an initial career position or a subsequent career position;
identify, by the career path search engine, a set of the career path objects that, when joined, define career paths from the initial career position, or to the subsequent career position, indicated in the career path query; determine an observed career path likelihood score for each career path based on the number of people that the employment history resources indicate have made the career transition for each career path object of the career path;
rank the career paths based on the observed career path likelihood scores;
select one or more of the top N-ranked career paths; and
provide, by the career path search engine, a search results page that includes a representation of the selected one or more top N-ranked career paths for output in response to the career path query.

33. The system of claim 32, the processor further operable to:
identify a set of employment history documents from one or more web sites;
analyze the employment history documents to determine observed career path data representing career paths taken by people associated with the employment history documents;
generate the career path objects based on the career path data; and
store the career path objects in the database of career path objects.

34. The system of claim 32, wherein the employment history documents include resumes, curricula vitae, and employee information web pages.

35. The system of claim 32, wherein the initial and subsequent nodes include qualification information representing additional qualifications possessed by the people associated with the positions represented by the nodes.

36. The system of claim 32, wherein the additional qualifications include education information.

37. The system of claim 32, the processor further operable to:
determine a likelihood of success for each observed career path in the set of career path objects based at least in part on the number of people who successfully made the career transition.

38. The system of claim 37, the processor further operable to provide a representation of the determined likelihood of success of each career path.

39. The method of claim 1, wherein at least two career path objects in the identified set of career path objects are associated with employment history documents relating to two or more different people.
